(19) United States
(12) Patent Application Publication
(10) Pub. No.: US 2026/0094542 A1
(43) Pub. Date: Apr. 2, 2026

(54) MULTI-LAYER LABELS AND PROCESS FOR MANUFACTURING THE SAME

(71) Applicant: ÉQUIPEMENTS DE TRANSFORMATION IMAC (E.T.I.) INC., Longueuil (CA)

(72) Inventors: Jean-François Lebel, Longueuil (CA); Maxime Bayzelon, Longueuil (CA); Marc-André Bélair, Longueuil (CA)

(73) Assignee: ÉQUIPEMENTS DE TRANSFORMATION IMAC (E.T.I.) INC., Longueuil (CA)

(21) Appl. No.: 18/983,981

(22) Filed: Dec. 17, 2024

Related U.S. Application Data
(60) Provisional application No. 63/611,389, filed on Dec. 18, 2023.

(51) Int. Cl. G09F 3/00; G09F 3/02; G09F 3/10

(52) U.S. Cl. CPC G09F 3/0297; G09F 3/10; G09F 2003/021; G09F 2003/0263

(57) ABSTRACT

The present invention is related to a multi-layer label product that comprises a shipment label in a first layer and a return label in a second layer along with complementary layers for properly bonding the first layer and the second layer in a multi-layer arrangement. The present invention further aims at improving the method by which a customer intends to make a product/order return by using the multi-layer label according to the present invention.

### CROSS-REFERENCE TO RELATED APPLICATIONS

The present patent application claims the benefits of priority of U.S. Provisional Patent Application No. 63/611,389 entitled “MULTI-LAYER LABELS AND PROCESS FOR MANUFACTURING THE SAME”, and filed at the United States Patent and Trademark Office on Dec. 18, 2023, the content of which is incorporated herein by reference.

### TECHNICAL FIELD

The present invention relates to a multi-layer label products and manufacturing method of such label products to be used in sales customer services and particularly for return of shipments. The present invention is also related to an Internet web-based process linked to order processing, return and shipment using the multi-layer label products.

### BACKGROUND

Online shopping which entails shipment deliveries at our doorsteps has become a norm, especially after the COVID 19 pandemic, and it is expected to rise due to a general change in customers purchasing habits.

Customer satisfaction is the top priority for entities that have online sale platforms for their commodities (e.g. Amazon). A significant part of customer service is to properly handle returns from customers. While a product return might be due dissatisfaction from the product per se, poorly handled return requests for such products may eventually cause customer to lose their interest in working with the particular sale platform which is in turn, detrimental to online sale business.

In an online selling platform, in order to initiate the return process for an already delivered shipment, the customer typically needs to: i) log into his/her account, ii) select the purchased product to be returned, iii) retrieve a document containing a return label with return instructions and/or barcodes for proper identification of the product, iv) print the document containing the return label and affixing it to the shipment box or any other box that contains the returning product, and v) return the product at an indicated post office.

These steps can be cumbersome and time-consuming and could be prone to errors. Part of the problem and complexity in the existing methods are due to the fact that there are multiple inconvenient steps in order to prepare a shipment for return and a single error in any of these steps would result in an unsuccessful return which results in customer dissatisfaction.

Moreover, the currently existing methods for product return present environmental issues. For instance, they generate substantial amount of wastes, either through materials printed by individuals or through multi-layer labels that have several layers such as liners that need to be discarded.

Therefore, there is a need for an improved return method involving a new type of label products that removes one or more of steps i) to iv) listed above, or preferably all of these steps.

### SUMMARY

This Summary is provided to introduce a selection of concepts in a simplified form that are further described below in the Detailed Description. This Summary is not intended to identify key aspects or essential aspects of the claimed subject matter.

Broadly stated, in some embodiments, the present invention relates to a multi-layer label for returning a delivered package containing a merchandise, the multi-layer label comprising:
a first layer configured to be affixed to the package and containing a first series of information associated with returning the merchandise, and
a second layer configured to be releasably attached to the first layer and containing a second series of information;
wherein the second layer tops the first layer such that the first series of information of the first layer is masked when the merchandise is shipped; and
   wherein the second series of information of the second layer comprises at least one readable code in connection with the first series of information.

Broadly stated, in some embodiments, the present invention relates to a method for returning a delivered package, the package comprising a multi-layer label comprising a first layer configured to be affixed to the package and having a first series of information associated with returning the package, and a second layer releasably attached to the first layer for covering at least in part the first layer such that the first series of information is masked when the package is shipped, the method comprising:
a) reading a readable code located on the second layer of the multi-layer label, wherein the readable code is associated to online records with respect to the merchandise including an invitation to remove the second layer when the package is to be returned,
b) removing the second layer from the multi-layer label to expose the first series of information associated with returning the package, and
c) returning the package.

Broadly stated, in some embodiments, the present invention relates to a web-based return system linked to order processing, return and shipment labels.

All features of exemplary embodiments which are described in this invention and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of specific exemplary embodiments is provided herein below with reference to the accompanying drawings in which:

FIG. 1 is an example of a multi-layer label comprising a first layer and a second layer according to a preferred embodiment.

FIG. 2 is an example of a first layer (e.g., a return label) according to a preferred embodiment.

FIG. 3 is an example of a second layer (e.g. a shipment label) superimposed on the first layer according to a preferred embodiment.

FIG. 4 is a schematic partial side view of a multi-layer label product that comprises a shipment label and a return label according to a preferred embodiment.

FIG. 5 is a schematic view of a manufacturing line for the making of the multi-layer label according to FIG. 4 and according to a preferred embodiment.

FIG. 6 is a flowchart illustrating the method for returning a delivered package according to a preferred embodiment.

FIG. 7 illustrates a graphical user interface by which a customer can finalize an online part of a return, according to a preferred embodiment.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant invention which variations and additions do not depart from the present technology. Hence, the following description is intended to illustrate some embodiments of the technology, and not to exhaustively specify all permutations, combinations, and variations thereof.

As used herein, the terminology “releasably attached” means an attachment that is not a permanent attachment.

The Applicant has designed and developed a process for manufacturing a multi-layer label for use in shipments handling and particularly for returning a delivered package that contains a merchandise. The multi-layer label according to the present invention is manufactured such that the resulting product comprises a first layer which is affixed to the package and a second layer that is releasably attached to the first layer. Using such multi-layer label allows customers receiving a delivered package to return the package containing a merchandise, if required, without the need for retrieving, obtaining, or receiving a separate return label from elsewhere and attaching it to the package. Instead, the customer is able to simply peel off the visible shipment label (by which the package had been delivered). This will in turn expose a return label underneath the shipment label that contains necessary information for returning the same package.

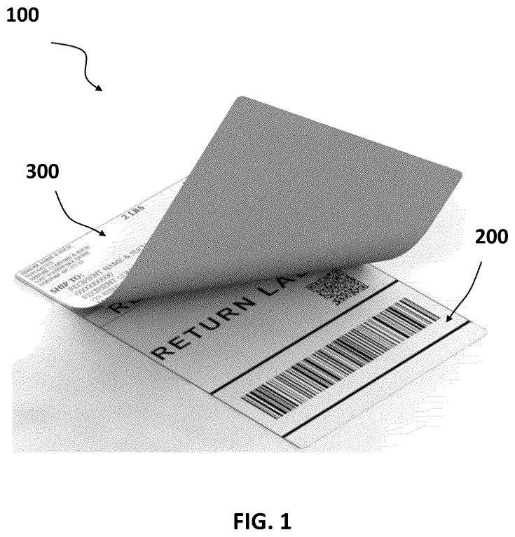

A non-limiting example of such multi-layer label is illustrated in FIG. 1. As depicted, the multi-layer label 100 is an assembly that comprises a first layer 200 and a second layer 300 topping the first layer such that the first layer may be at least partially masked by the second layer.

In a preferred embodiment, the first layer 200 is a return label that comprises a first series of information and the second layer 300 is a shipment label that comprises a second series of information. The second layer 300 tops the first layer 200 and is releasably attached thereto meaning that the attachment between the first layer 200 and the second layer 300 is not permanent and that the first layer 200 and the second layer 300 may be partially or fully detached without damage.

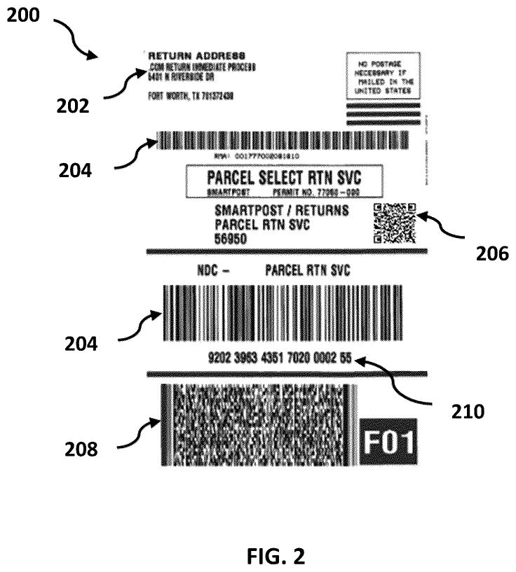

FIG. 2 is a non-limiting example of the first layer 200 (i.e., the return label) of the multi-layer label shown in FIG. 1. As explained above, the first layer 200 includes a first series of information that allows returning a package that has already been delivered to a customer. Non-limiting examples of the first series of information could be:
a return address (202);
one or more shipment logistic tracking codes such as barcodes (204) or QR codes (206);
other computer-readable codes (208);
a tracking number (210).

It will be apparent to the person skilled in the art that each of the one or more shipment logistic tracking codes such as barcodes 204 or QR codes 206 or other computer-readable codes 208 may contain information that are associated to the return of the package or the merchandise therein. These information could be obtained using a computer-readable device (such as a standalone scanner or a scanning function within an application on a smart phone or tablet) that can read and decode barcodes, QR codes or other computer-readable codes. Non-limiting examples of such information could be order number, merchandise serial number, date the merchandise was ordered, shipping company, etc.

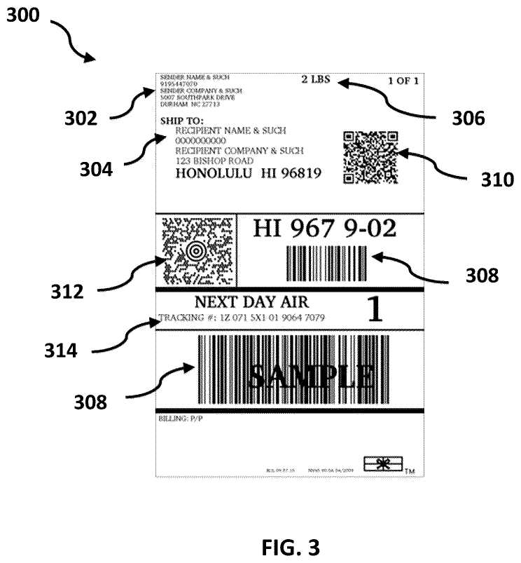

FIG. 3 is a non-limiting example of the second layer 300 (i.e. the shipment label) of the multi-layer label 100 shown in FIG. 1. Similar to the first layer 200, the second layer includes a second series of information that allows delivery of the package to the customer that has placed an order for a specific merchandise. Non-limiting examples of the second series of information could be:
sender's name and address (302);
shipping/receiver's address (304);
shipment weight (306);
one or more shipment logistic tracking codes such as barcodes (308) or QR codes (310);
other computer-readable codes (312);
tracking number (314).

It will be apparent to the person skilled in the art that each of the one or more shipment logistic tracking codes such as barcodes 308 or QR codes 310 or other computer-readable codes 312 may be related to information that are associated to the delivery of the package or the merchandise therein. These information could be obtained using a computer-readable device (such as a standalone scanner or a scanning function within an application on a smart phone or tablet) that can read and decode barcodes, QR codes or other computer-readable codes. Non-limiting examples of such information could be order number, merchandise serial number, date the merchandise was ordered, shipping company, etc.

In some embodiments, the first layer 200 and the second layer 300 may be separated by one or more intermediate layers. These intermediate layers may contribute to the initial bonding or superposition of the layers within the multi-layer labels or detachment/separation (e.g. peel off) of these layers. Examples of the one or more intermediate layers may include adhesive layers, silicon layer, and varnish.

The second layer (i.e. the shipment label) as the one illustrated on FIG. 3, includes a barcode, a QR code or another readable code 310 that associates a particular package (or merchandise therein) to an online database of ordered merchandise and a list of orders placed by the customer for managing possible returns of one or more shipped orders. The online database of orders and the list of orders placed by the customer (for the purpose of return), will be described herein later.

In some embodiments, the multi-layer label 100 may comprise one or more adhesive layers backing the first layer 200 and the second layer 300. These adhesive layers facilitate either the bonding between the first layer 200 and the second layer 300 or the bonding between the first layer and the package. The one or more adhesive layers could be of pressure-sensitive type. Non-limiting examples of adhesives include rubber-based hotmelt, UV-curable acrylic hotmelt, acrylic water-based adhesive and combinations thereof.

In other embodiments, the multi-layer label 100 may comprise one or more silicon layers. The one or more silicone layers may be adhesive-backed. The one or more silicon layers are configured to releasably attach layers in the multi-layer label and in turn lead to releasable detachment of the layers (for example, release of the multi-layer label from the liner at the point where the label is applied to the package or release of the second layer 300 from the first layer 200).

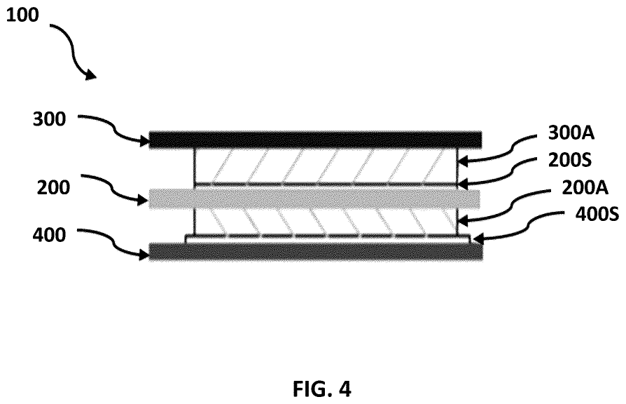

FIG. 4 is schematic side view of a multi-layer label 100 according to one preferred embodiment. In this embodiment, the multi-layer label 100 comprises the second layer 300 superimposed on the first layer 200 along with one or more intermediate layers as will be described now. The first layer 200 (i.e. the return label) tops an adhesive layer 200A which facilitates affixture of the multi-layer label 100 to a package. It will be apparent to the person skilled in the art that while the description describes affixture of the multi-layer label 100 to the package, it is in fact the first layer 200 that adheres to the surface of the package with the adhesion offered by the adhesive layer 200A.

Furthermore, the adhesive layer 200A may top a silicon layer 400S which is configured to facilitate detachment of the multi-layer label 100 from a release liner 400 (along with the silicon layer 400S) prior to initial affixture to the package.

Alternatively, the multi-layer label 100 may be configured to be linerless meaning that the adhesive layer 200A is affixed directly to the package.

Similarly, the second layer 300 (i.e. the shipment label) tops an adhesive layer 300A which facilitates affixture of the second layer 300 to the first layer 200 to form the multi-layer label 100. The adhesive layer 300A tops another silicon layer 200S which is configured to facilitate releasable detachment of the second layer 300 from the first layer 200 (i.e. the peel off) such that the first layer 200 and the first series of information are exposed.

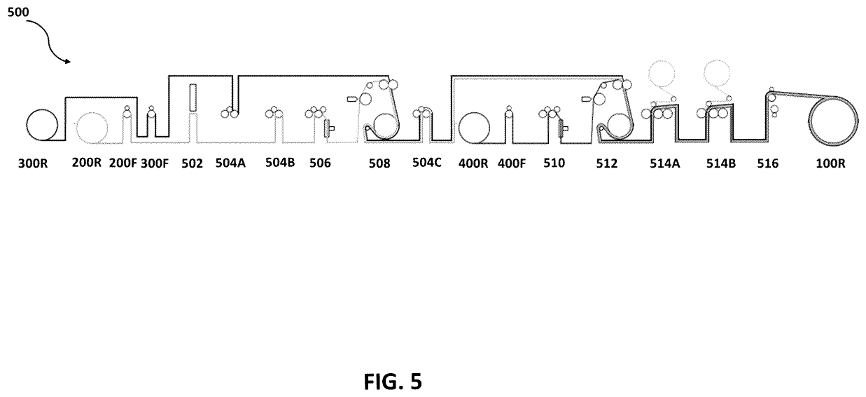

FIG. 5 is a non-limiting example and simplified schematic view of a process line 500 for manufacturing the multi-layer label described in FIG. 4 according to a preferred embodiment. The process starts by concurrently unwinding a continuous roll of shipment label 300 in a first roller 300R and unwinding a continuous roll of return label 200 in a second roller 200R. The two rolls of the shipment label 300 and the return label 200 are fed separately and through anvil rollers 300F and 200F, respectively. Since both the shipment label 300 and the return label 200 are supposed to contain certain information, these information are printed while passing through a digital printing module 502.

Both the shipment label 300 and the return label 200 further pass through flexography stations 504A and 504B to print at the back of the multi-layer label such that the information on the return label are properly masked-in the production stage.

Next, the return label 200 passes through a silicon coating station 506 wherein the return label is topped/coated by the layer of silicon 200S. The silicon coating may be a UV curable type of coating. Following the silicon coating, both the shipment label 300 and the return label 200 pass through a slot die 508 so that they are laminated. Subsequently, after lamination, another flexography station 504C is used to print constant information (such as constant titles including but not limited to “Sender name”, “Ship to”, etc.) on the shipment label. Once the shipment label 300 and the return label 200 are laminated and passed through 504C, the process 500 continues by unwinding a continuous roll of release liner 400 in a third roller 400R which is fed through anvil roller 400F.

Next, the liner 400 is passed through a silicon coating station 510 in which it is topped/coated by the layer of silicone 400S. The silicon coating may be a UV curable type of coating. Following the silicon coating, the silicon-coated liner passes through a slot die 512 so that it gets laminated to the already made laminate of shipment label 300 and return label 200. Upon lamination, there are two die cut stations 514A and 514B with the former 514A being configured to impart cuts on the shipment label and the latter 514B being configured to impart cuts on the laminated return and shipment labels. The laminated multi-layer label which comprises both the shipment label 300 and the return label 200 (both of which containing information) is subsequently transferred to the final rolling station by the anvil roller 516 and rolled in the rewinding station 100R as the final multi-layer label product 100.

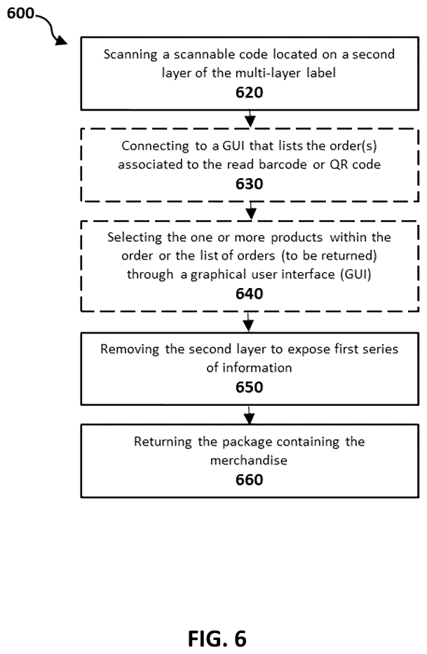

As explained above, the multi-layer label 100 aims at facilitating shipment/package handling all the way from shipping to the customer and specifically for return (if required) to the initial sender (e.g., selling platform, warehouse, etc.). FIG. 6 illustrates a flowchart corresponding to a method 600 for returning a delivered package containing a merchandise according to a preferred embodiment.

The return process commences at step 620 by which the customer who desires to return a delivered package uses a reading device (including but not limited to a scanning tool) to read a particular code (such as a barcode, QR code 310 or any other computer-readable code) on the shipment label 300 which is in connection with the package return. Such code reading establishes an online connection to online records regarding the merchandise in the delivered package which allows the user to only initiate an online return transaction by selecting orders that need to be returned. Once the selection is done, the method proceeds to step 650 wherein the customer receives instructions to remove the top label (i.e. the shipment label 300) to expose the return label 200 along with the return first series of information thereon including a readable code (such as the QR code 206). The customer will then use the reading device to read said readable code on the return label 200 to conclude the online return transaction.

In an alternative embodiment, the customer who desires to return a delivered package uses a reading device (including but not limited to a scanning tool such as a smartphone or tablet) to read a particular code (such as a barcode, QR code 310 or any other computer-readable code) on the shipment label 300 which is in connection with the package return. Such code reading establishes an online connection to online records regarding the merchandise in the delivered package which allows the user to initiate and conclude an online return transaction by selecting orders that need to be returned. Such online transaction will be further described later. Once the online return transaction is concluded, the method proceeds to step 650 wherein the customer receives instructions to remove the top label (i.e. the shipment label 300) to expose the return label 200 along with the return first series of information thereon.

Finally, the process is concluded by physically returning the package containing the merchandise at step 660. Such return could be either by depositing the package at a mailing service location or by scheduling a pick up at a location specified by the customer such that it can be picked up by a mailing service and returned to a point of return (such as a warehouse).

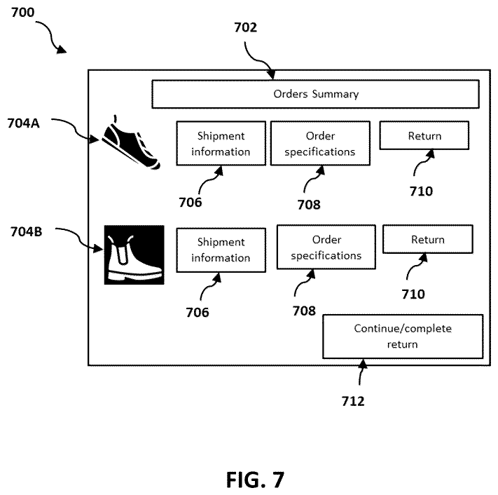

In another embodiment, and as will be explained along with the system illustrated on FIG. 7, the method 600 for returning a delivered package starts by step 620 by which the customer who wants to return a delivered package is invited to scan a particular code 310 (a barcode, a QR code or any other computer-readable code) on the shipment label 300. The code 310 is associated with information related to the return of the package and the merchandise therein. In an embodiment, reading/scanning the second barcode or QR code 310 can be done by an application on a smart phone or tablet that has an embedded scanning function. In another embodiment, reading/scanning the second barcode or QR code 310 can be done by a separate reader or scanner that is connected to (in communication with) an application on a PC, tablet, smart phone, etc. The scanning could also be within an application on a smart phone or tablet. Once the second barcode or QR code 310 on the shipment label is scanned and read, the customer at step 630 is connected/directed to a graphical user interface (GUI) 700 presenting a summary of ordered merchandise s are presented.

A non-limiting example of the GUI 700 is shown in FIG. 7 in which a summary of the merchandise order(s) is presented. A non-limiting list of information presented by the GUI 700 could be:
Illustrated ordered merchandise(s) 704A-B
Shipment information 706 which may include order number, price, tracking number, etc.
Order specifications 708 which may include: size, type, color, manufacturer, brand, etc.
Return 710 by which the customer is allowed to choose the specific order(s) to be returned.

The customer at step 640 may select one or more ordered merchandise(s) for return through buttons 710 to make a return. Once the return choices are made, the customer at step 640 is able to finalize an online return transaction by pressing the continue/complete return button 712 in the GUI and conclude the online return process. The customer may then be redirected to a secondary page in the GUI (not shown) to choose a return at a service location or schedule a pick-up.

Once the online return process is concluded, the customer at step 650 is invited to remove the second layer (i.e. the shipment label 300 as illustrated in FIG. 1 and FIG. 3) Such that the return label 200 along with the first series of information is now exposed. Finally, and in order to fully complete the return, the customer will return the physical package and the merchandise therein at step 660.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the scope of the present invention.

What is claimed is:

1. A multi-layer label for returning a delivered package containing a merchandise, the multi-layer label comprising:
a first layer configured to be affixed to the package and containing a first series of information associated with returning the merchandise, and
a second layer configured to be releasably attached to the first layer and containing a second series of information;
wherein the second layer tops the first layer such that the first series of information of the first layer is masked when the merchandise is shipped; and
wherein the second series of information of the second layer comprises at least one readable code in connection with the first series of information.

2. The multi-layer label according to claim 1, wherein the second series of information further comprises information associated with initial delivery of the merchandise.

3. The multi-layer label according to claim 1, further comprising a first adhesive layer affixed to the first layer for providing adhesion to the package.

4. The multi-layer label according to claim 3, further comprising a second adhesive layer affixed to the second layer for providing adhesion to the first layer.

5. The multi-layer label according to claim 1, further comprising a second adhesive layer affixed to the second layer for providing adhesion to the first layer.

6. The multi-layer label according to claim 1, further comprising a supporting liner and a first silicon layer affixed to the supporting liner for facilitating detachment of the first layer from the supporting liner prior to affixture of the first layer to the package.

7. The multi-layer label according to claim 6, further comprising a second silicon layer affixed to the first layer, for allowing detachment of the second layer from the first layer.

8. The multi-layer label according to claim 1, further comprising a second silicon layer affixed to the first layer, for allowing detachment of the second layer from the first layer.

9. The multi-layer label according to claim 1, wherein the at least one readable code is configured to implement a graphical user interface (GUI) on a computing device, such as a smartphone or a tablet, the GUI being configured to finalize an online return transaction.

10. The multi-layer label according to claim 1, wherein the readable code is a scannable code.

11. A method for returning a delivered package, the package comprising a multi-layer label comprising a first layer configured to be affixed to the package and having a first series of information associated with returning the package, and a second layer releasably attached to the first layer for covering at least in part the first layer such that the first series of information is masked when the package is shipped, the method comprising:
a) reading a readable code located on the second layer of the multi-layer label, wherein the readable code is associated to online records with respect to the merchandise including an invitation to remove the second layer when the package is to be returned,
b) removing the second layer from the multi-layer label to expose the first series of information associated with returning the package, and
c) returning the package.

12. The method according to claim 11, wherein the reading of the readable code implements a graphical user interface (GUI) on a computing device for finalizing the returning step.

13. The method according to claim 11, wherein the readable code is a scannable code.
